(19) United States
(12) Patent Application Publication
(10) Pub. No.: US 2011/0287196 A1
(43) Pub. Date: Nov. 24, 2011

(54) ELECTRO-OPTICAL SWITCHABLE WINDOW

(76) Inventors: Robert Shaw, Independence, OH (US); Adrian deKrom, Newbury, OH (US)

(21) Appl. No.: 12/783,066

(22) Filed: May 19, 2010

(51) Int. Cl. C09K 19/52; B32B 37/00; G02F 1/13

(52) U.S. Cl. 428/1.55; 428/1.5; 156/146

(57) ABSTRACT

A switchable window comprising a coating layer disposed between a first substrate and a second substrate, the coating layer comprising a plurality of liquid crystals, at least one monomer, and at least one oligomer wherein the weight percentage of the at least one oligomer is greater than the weight percentage of the at least one monomer.

### FIELD OF INVENTION

The present invention is generally related to an electro-optical switchable liquid crystal window and polymer compositions for providing such.

### BACKGROUND

Conventional liquid crystal (LC) devices that may be used as electro-optical switchable windows generally comprise a liquid crystal layer of controlled thickness sandwiched between two substrates. Each substrate is transparent and coated with a transparent, electrically conductive coating on the side facing the liquid crystal layer to enable an electrical field to be applied to the layer. The substrates may be glass or a polymer substrate film. If the substrates are film then it may be possible to laminate the liquid crystal coating layer to regular window glass panes on one or both sides by employing an adhesive sheet known as an interlayer. Such a combined LC film and glass laminate is known as a switchable window.

There are several known polymer-LC structures. Each suffers from drawbacks. Some are fundamentally unsuitable for lamination in this type of structure, whereas those that can be laminated suffer from optical problems such as excessive haze or an excessively limited range of useful transparent viewing angles. In addition, the curing of prior coating layers required significant curing time and energy which has lead to increase costs for producing switchable windows.

When considering such problems it is necessary to evaluate and balance the conflicting requirements for a given application. Thus, while it may be relatively trivial to reduce haze or increase viewing angles for a particular film by reducing the thickness of the polymer-LC film, this can have a direct impact on the ability of the film to block light when in the supposed blocking state. Ensuring an acceptable level of opacity in the blocking state may require a film of a thickness which, in the supposedly transparent state, is inherently hazy and has very limited viewing angles.

### SUMMARY

The present invention provides a switchable window that can be operated to switch between a transparent state to and an opaque state. The switchable window comprises a coating layer dispersed between a first substrate and a second substrate to form the switchable window.

In one aspect, the present invention provides a switchable window comprising a first substrate, a second substrate and a coating layer disposed between a first substrate and a second substrate, said coating layer comprising a plurality of liquid crystal elements, at least one monomer and at least one oligomer, wherein the wt. % of said at least one oligomer is greater than the wt. % of said at least one monomer in said coating layer.

Applicants have created and developed a coating layer that exhibits excellent adhesive properties and provides for a switchable window that has substantially improved clarity when in the transparent state.

The coating layer also provides for an improved method of making switchable windows as the coating is amenable to coating methods such as roll coating and exhibits relatively quick cure times, which requires less energy and lowers the costs for processing.

In another aspect, the invention provides a method for making a switchable window comprised of applying a coating layer to a first substrate, comprising at least one monomer, at least one oligomer wherein the weight percentage of said at least one oligomer in said coating layer is greater than the weight percentage of said at least one monomer in said coating layer, liquid crystal, at least one spacer and may or may not include: at least one surfactant, at least one curing agent and/or at least one solvent; placing a second substrate on said first substrate with said coating layer being disposed between the first substrate and the second substrate; and curing the coating layer.

The present invention provides for a liquid crystal coating layer that has improved structural advantages of compatibility with lamination to glass, such as better adhesion, but may also have improved clarity and/or improved light transmission. In addition, the present invention provides for a liquid crystal coating layer that may be cured in a relatively short time period and requires relatively low energy to effect curing as compared to prior liquid crystal coating layers. These features significantly reduce the cost of producing switchable windows.

Further, the present invention provides for a coating layer that exhibits one or more of the above qualities and can be easily applied to substrates by such means as roll coating or other processes hereinafter stated.

### DESCRIPTION OF THE DRAWINGS

Objects and advantages together with the operation of the invention may be better understood by reference to the following detailed description taken in connection with the following illustration, wherein:

FIG. 1 illustrates a cross-sectional view of a switchable window in accordance with an embodiment of the invention.

### DETAILED DESCRIPTION

Reference will now be made in detail to exemplary embodiments of the present invention, examples of which are illustrated in the accompanying drawing. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

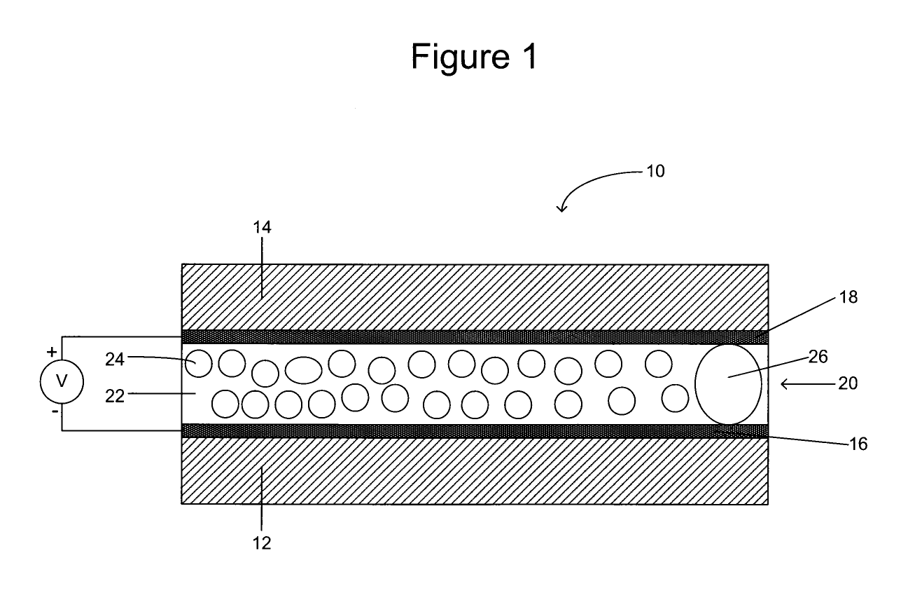

Referring to FIG. 1 the present invention provides, in one aspect, a switchable window 10 comprising a coating layer 20 disposed between a first substrate 12 and a second substrate 14. In one embodiment, the first substrate 12 and second substrate 14 are transparent but they may also be translucent. The coating layer 20 may be comprised of a matrix 22 with liquid crystals 24 dispersed therein. The first substrate 12 and second substrate 14 may be coated by conductive layers 16, 18 which are in contact with the coating layer 20. The coating layer 20 may be applied by such means as roll coating. The combination of the coating layer 20 between the first substrate 12 and second substrate 14 allows the switchable window 10 to be switched between a light transmissive state and a substantially opaque state depending on whether an electrical current is applied to the device or not.

As used herein, the term “coating layer” be used interchangeably in referring to the coating layer in either the cured or the uncured state. In the uncured state, the matrix 22 may be a fluid or pre-polymer solution comprising constituent components that, when subjected to curing, such as, for example, by exposure to UV radiation, form an adhesive coating composition. In the cured state, the matrix 22 may be referred to as a polymer matrix as it contains a polymer network formed by the reaction of the constituent components. In the cured state, the coating layer 20 may also be referred to as an adhesive electro-optical coating layer.

Prior to curing, the coating layer 20 comprises a composition comprising liquid crystal elements, at least one monomer, and at least one oligomer. In the coating layer 20, the oligomer is present in a concentration greater than the concentration of the monomer. Applicants have found that by providing the oligomer in a greater concentration then the monomer, a coating layer 20 may be provided having particularly desirable properties for use in a switchable window.

Examples of suitable monomers for use in the coating layer include, but are not limited to, acrylates, methacrylates, acrylic acids and ionic salts thereof, methacrylic acids and ionic salts of the acids, or combinations of two or more thereof. In one embodiment, the coating layer comprises one or more monomers having good dielectric properties and/or that are polymerizable at relatively low energy.

Examples of methacrylates suitable as the monomer component in the coating layer 20, whether as the sole monomer or as a co-monomer, include, but are not limited to, hydroxyethyl methacrylate, ethyl methacrylate, methyl methacrylate, 2-ethylhexyl methacrylate, butylethyl methacrylate, butoxyethyl methacrylate, 2-cyanoethyl methacrylate, benzyl methacrylate, ethylbenzyl methacrylate, n-hexyl methacrylate, n-octyl methacrylate, n-decyl methacrylate, cyclohexyl methacrylate, 2-hydroxypropyl methacrylate, 2-ethoxyethyl methacrylate, N,N-diethylaminoethyl methacrylate, N,N-dimethylaminoethyl methacrylate, dicyclopentanyl methacrylate, dicyclopentenyl methacrylate, glycidyl methacrylate, tetrahydrofurfuryl methacrylate, n-butyl methacrylate, isobutyl methacrylate, tert-butyl methacrylate, hydroxybutyl methacrylate, isobornyl methacrylate, isodecyl methacrylate, lauryl methacrylate, morpholine methacrylate, phenoxyethyl methacrylate and phenoxydiethyleneglycol methacrylate.

Examples of acrylates suitable as the monomer component in the coating layer 20, whether as the sole monomer or as a co-monomer, include, but are not limited to, ethyl acrylate, 2-ethylhexyl acrylate, 2-ethyl-hexanolacrylate, butylethyl acrylate, butoxyethyl acrylate, 2-cyanoethyl acrylate, benzyl acrylate, cyclohexyl acrylate, 2-hydroxypropyl acrylate, hydroxyethyl acrylate, 2-ethoxyethyl acrylate, N,N-diethylaminoethyl acrylate, N,N-dimethylaminoethyl acrylate, isooctyl acrylate, dicyclopentanyl acrylate, dicyclopentenyl acrylate, glycidyl acrylate, tetahydrofurfuryl acrylate, ethylbenzyl acrylate, butyl acrylate, isobornyl acrylate, isodecyl acrylate, n-decyl acrylate, n-hexyl acrylate, 1-methylheptyl acrylate, octyl acrylate, 2-methylheptyl acrylate, lauryl acrylate, morpholine acrylate, phenoxyethyl acrylate and phenoxydiethyleneglycol acrylate.

Examples of acrylic acids or salts of acrylic acids, suitable as the monomer components in the coating layer 20, whether as the sole monomer or as a co-monomer, include, but are not limited to, acrylic acid, methacrylic acid, salts of acrylic acids, salts of methacrylic acids, or combinations of two or more thereof. Examples of salts of acrylic and methacrylic acids include but are not limited to, sodium, potassium, lithium, magnesium, barium, and the like, or combinations of two or more thereof. In one embodiment, the coating layer 20 comprises acrylic acid, which exhibits good electroconductivity once polymerized. In addition, acrylic acid is clear and colorless.

Examples of oligomers suitable for use in the present invention in the coating layer 20 include multi-functional acrylates and multi-functional methacrylates. In one embodiment, the oligomer is chosen from an acrylated urethane oligomer, a methacrylated urethane oligomer, acrylated or methacrylated urethane oligomers containing polyester or polyether backbones, or combinations of two or more thereof. Examples of suitable acrylated urethane oligomers include, but are not limited to, aliphatic polyether urethane acrylates, diacrylates, and polyacrylates, aliphatic and polyester urethane acrylates, diacrylates, and polyacrylates. Examples of suitable methacrylated urethane oligomers include, but are not limited to, polyether urethane methacrylates, dimethacrylates and polymethacrylates, and polyester urethane methacrylates, dimethacrylates, and polymethacrylates. Examples of suitable commercially available oligomers include those available from Sartomer USA, LLC such as Sartomer®CN1963, Sartomer®CD400, Sartomer®SR454, Sartomer®CN966H90, and Sartomer®SB520M35.

Examples of methacrylates suitable as the oligomer component for use in the coating layer 20, whether as the sole oligomer or as a co-oligomer, include, but are not limited to, urethane methacrylate; ethyleneglycol dimethacrylate, diethyleneglycol dimethacrylate, 1,4-butanediol dimethacrylate, 1,3-butyleneglycol dimethacrylate, dicyclopentanyl dimethacrylate, glycerol dimethacrylate, 1,6-hexanediol dimethacrylate, neopentylglycol dimethacrylate, tetraethyleneglycol dimethacrylate, 1,4-butanediol dimethacrylate, bisphenol-A dimethacrylate, trimethylolpropane trimethacrylate, pentaerythritol tetramethacrylate, pentaerythritol trimethacrylate, ditrimethylolpropane tetramethacrylate, dipentaerythritol hexamethacrylate, dipentaerythritol monohydroxypentamethacrylate, and the like.

Examples of acrylates suitable as the oligomer component, whether as the sole oligomer or as a co-oligomer, include, but are not limited to urethane acrylate, aliphatic polyester urethane diacrylate oligomer blended with 2(2-ethoxyethoxy) ethyl acrylate, diethyleneglycol diacrylate, 1,4-butanediol diacrylate, 1,3-butyleneglycol diacrylate, dicyclopentanyl diacrylate, glycerol diacrylate, 1,6-hexanediol diacrylate, neopentylglycol diacrylate, tetraethyleneglycol diacrylate, trimethylolpropane triacrylate, pentaerythritol tetraacrylate, pentaerythritol triacrylate, tripropyleneglycoldiacrylate, ditrimethylolpropane tetraacrylate, dipentaerythritol hexaacrylate, dipentaerythritol monohydroxypentaacrylate, and triacrylate.

In one embodiment, the coating layer comprises a methacrylate oligomer. Applicants have found that employing a methacrylate oligomer such as a urethane methacrylate oligomer, provides a coating layer 20 that exhibits relatively quick cure times and provides a polymer matrix having excellent adhesion, hardness, weatherability, as well as imparting excellent impact strength to the finished switchable window.

In the coating layer 20, the oligomer is present in an amount greater than that of the monomer. Applicants have found that a coating layer 20 having a larger amount of oligomer than monomer provides a polymer matrix with excellent properties such as excellent adhesion. In one embodiment, the coating layer 20 may comprise from about 8 wt. % to about 35 wt. % of oligomer. In another embodiment, the coating layer 20 comprises from about 10 wt. % to about 20 wt. % of oligomer. In another embodiment, the coating layer 20 comprises from about 12 wt. % to about 16 wt. % of oligomer. In one embodiment, the coating layer 20 comprises less than about 10 wt. % of monomer. In another embodiment, the coating layer 20 comprises from about 0.1 wt. % to about 7 wt. % of monomer. In another embodiment, the coating composition comprises from about 2 wt. % to about 5 wt. % of monomer. As used herein, the wt. % refers to the total weight of the coating layer 20 before curing.

Applicants have further found that controlling the ratio of the oligomer to the monomer may provide a coating layer 20 with particularly desirable qualities. In one embodiment, the ratio of wt. % of oligomer in the coating layer 20 to wt. % of monomer in the coating layer 20 is from about 1.1:1 to about 300:1. In another embodiment, the ratio of wt. % of oligomer to wt. % of monomer is from approximately 1.25:1 to about 7:1. In another embodiment, the ratio of wt. % of oligomer to wt. % of monomer is from approximately 1.5:1 to about 5:1. In another embodiment the ratio of wt. % of oligomer to wt. % of monomer is from approximately 2:1 to about 4:1. In another embodiment the ratio of wt. % of oligomer to wt. % of monomer is from approximately 2.25:1 to about 3:1. In another embodiment the ratio of wt. % of oligomer to wt. % of monomer is from approximately 2.4:1 to about 2.75:1.

The liquid crystal elements 24 may be selected as desired for a particular purpose or intended use. Examples of suitable liquid crystal materials include, but are not limited to, nematic liquid crystal, smectic liquid crystal, blue liquid crystal, discotic liquid crystal, lyotropic liquid crystal, or metallotropic liquid crystal. The liquid crystal material may be chosen based on the refractive index. In one embodiment, the liquid crystals employed may have a refractive index substantially similar to the refractive index of the matrix 22 in the coating layer 20 when the coating layer 20 is cured. The refractive index of the selected liquid crystal may range from about 1.400 to about 1.650. In an exemplary embodiment, the selected liquid crystal is a nematic liquid crystal with a refractive index of approximately 1.520. The liquid crystal 24 may be present in the coating layer 20 in an amount of about 55 wt. % to about 80 wt. % of the coating layer 20. In another embodiment, the liquid crystal 24 may be present in the coating layer 20 in an amount of about 60 wt. % to about 70 wt. % of the coating layer 20.

The matrix 22 may include other components that may be suitable for forming the coating layer 20 and polymer matrix. Such components may include a surfactant, a solvent, a curing agent, a spacer 26, and the like.

The coating layer may include a surfactant. The surfactant may provide the coating layer 20 with good wetting characteristics desirable for the coating process. Applicants have also found that the addition of a surfactant may help to avoid the formation of pin holes in the cured coating layer. The amount of surfactant present in the coating layer 20 can range from about 0 wt. % to about 3 wt. %. Examples of surfactants for use in the present invention in the coating layer 20 are, but not limited to, fluorosurfactants, silicone surfactants, ionic surfactants, and non-ionic surfactants, combinations thereof, and the like.

The coating layer may further comprise a solvent. The solvent present may range from about 0 wt. % to about 10 wt. %. Examples of suitable solvents in the coating layer 20 include, but are not limited to, ethyl alcohol, denatured ethyl alcohol, ethyl alcohol denatured with ethyl acetate and methyl isobutyl acetone, methyl alcohol, isopropyl alcohol, acetone, methyl ethyl ketone, butyl acetate. Applicants have found that the inclusion of a solvent may provide a coating layer 20 that exhibits a relatively low viscosity, which may allow for more uniform dispersion of the liquid crystals or spacer elements, and may be beneficial for various coating methods such as, for example, reverse roll coating.

The coating layer may further comprise a curing agent. The curing agent present in the coating layer 20 can range from about 0.01 wt. % to about 3 wt. %. The curing agent may act as a photoinitiator. Examples of suitable curing agents include, but are not limited to, 1-Hydroxy-cyclohexyl-phenyl-ketone; benzophenone; Camphorquinone; (1-hydroxycyclohexyl) phenyl ketone; 1-[4-(2-hydroxyethyoxy)-phenyl]-2-hyrdoxy-2-methyl-1-propane-1; 3,4-dimethylbenzophenone; 2,2, diethyloxyacetophenone; (4,bromophenyl) diphenyl sulfonium triflate; a mixture of Bis(1,2,2,6,6-pentamethly-4-piperidinyl)-sebacate and 1-(Methyl)-8-(1,2,2,6,6-pentamethyl-4-piperidinyl)-sebacate; and 4,4-dimethoxybenzoin; and combinations of two or more thereof, and the like. Examples of commercially available materials suitable as the curing agent, either alone or in combination with one or more other curing agents, include those sold under the tradename Irgacure®, Darocur®, or Tinuvin®, all available from Ciba. Specific, non-limiting examples of suitable Irgacure®, Darocur®, and Tinuvin® curing agents include Irgacure® 184, Irgacure® 369, Irgacure® 819, Irgacure® 1300, Darocur® TPO, Darocur® 1173, Darocur® 4265, Tinuvin® 292, and Tinuvin® 400.

The coating layer 20 may also exhibit other properties desirable for a switchable window 10. For example, the coating layer 20 may be resistant to yellowing, have relatively strong adhesive qualities, have good electrical conductivity, require low amounts of energy to effect curing, and good durability.

Applicants have found a coating layer 20 that exhibits properties that are particularly suitable for a switchable window device. In one aspect, the coating layer 20 exhibits a viscosity particularly suitable for various coating methods, including roll coating. In one embodiment the coating layer 20, prior to curing, has a viscosity that can range from about 30 cps to about 70 cps. In another embodiment, the coating layer 20, prior to curing, has a viscosity that can range from about 35 cps to about 50 cps. In another embodiment, the coating layer 20, prior to curing, has a viscosity of about 40 cps.

The coating layer 20 may also include spacer elements 26. The amount of spacer elements 26 present in the coating layer 20 can range from about 3 wt. % to about 15 wt. %. Examples of suitable spacer materials include, but are not limited to, soda lime glass spheres, glass spheres, and any other spacer material as may be suitable for a particular purpose or intended use. In one embodiment the selected spacers 26 may have a refractive index similar to the refractive index of the liquid crystals 24 and/or materials in the coating layer 20. In one embodiment the selected spacer is a soda lime glass sphere with a refractive index of approximately 1.400 to about 1.600. The size of the spacers may be selected as desired to suit a particular purpose or need. In one embodiment, the spacers may have a size ranging from about 5 μm to about 50 μm. In another embodiment, the spacers may have a uniformity ranging from approximately 85% to 98%, but may have any uniformity as desired.

The thickness of the coating layer 20 is not particularly limited and may be chosen as desired provided that the thickness provides suitable properties such as optical clarity and the like. The thickness of the coating layer 20 may be controlled by the size of the spacers 26 in the coating layer 20. In one embodiment, the coating layer may have a thickness in the range of about 8 μm to about 40 μm.

The first substrate 12 and the second substrate 14 may also be referred to as electrically conductive substrates, and may be selected from any desirable material. Suitable materials for the substrate include, for example, glass, a polymer substrate film, and the like. For substrate materials that are generally non-conductive, e.g. glass, the substrate may be made conductive by application of an electrically conductive coating layer thereto. For example, as shown in FIG. 1, the first substrate 12 may have a conductive electrode coating 16 on the side facing the coating layer 20 and the second substrate 14 may have a conductive electrode coating 18 on the side facing the coating layer 20 to facilitate applying an electric field across the coating layer 20. Examples of suitable conductive coatings include, but are not limited to, indium tin oxide, tin oxide, inherently conductive polymers, aluminum-doped zinc oxide, carbon nanotubes, combinations of two or more thereof, and the like.

It will be appreciated that structural and functional changes may be made to the device by modifying the conductive coated side of the substrate. For example, at least a portion of the conductive coating may be removed to create a design or a desired function to control the substrate as desired by each preferential design or function. Such modifications may require separate or collective electrical connections applied to the specific or designated portion(s) of the conductive substrate to achieve the preferred design or function. Such design or function such as, for example, a logo or various designs or functional control of light transmission to a designated portion(s) of the substrate may allow the substrate to exhibit both an opaque state and a clear, transmissive state in the same substrate at the same time.

The coating layer 20 may be provided as an uncured composition comprising a mixture of at least one oligomer, at least one monomer, at least one surfactant, at least one solvent, and at least one curing agent. Optionally, at least one spacer 26 may be added to the coating layer 20. The spacers 26 may be dispersed throughout the coating layer 20. At least one liquid crystal 24 may be added to the coating layer 20, which may or may not include a spacer element. The liquid crystals 24 may be dispersed throughout the coating layer 20. As described above, prior to curing, the coating layer is generally provided as a fluid formulation.

In one embodiment, a method of forming a switchable window 10 comprises applying a coating layer 20 to a surface of a first substrate 12 and then placing a second substrate 14 on top of the coating layer 20 and the first substrate 12, with the coating layer 20 lying in between the first substrate 12 and the second substrate 14. The coating layer 20 may be applied to a substrate by any suitable method, including, but not limited to, roll coating, reverse roll coating, curtain coating, spray coating, air knife coating, immersion coating, slot die coating, metering rod coating, gravure coating, and applied in any other fashion already known to one skilled in the art. In one embodiment, the first substrate 12 has a conductive electrode coating 16, and coating layer 20 is applied over the conductive electrode coating 16.

The coating layer 20 may then be cured by subjecting the entire apparatus to radiation to form a switchable window 10. Upon curing, the monomer and oligomer components react to form a polymer matrix having the liquid crystals dispersed therein. While not being bound to any particular theory, it is believed that the cured coating layer contains some partially cured components and solvent within the polymer matrix, which imparts some flexibility to the coating layer. In one embodiment the radiation used to cure the coating layer 20 may be UV radiation but the radiation may also be any other type of radiation known in the art. The UV radiation may be applied for at least 0.1 minutes to about 600 minutes. In one embodiment, the UV radiation may be applied for less than 20 minutes. In another embodiment, the UV radiation may be applied for less than 10 minutes. In another embodiment, the UV radiation may be applied from about 1 minute to about 20 minutes. In another embodiment, the UV radiation may be applied from about 6 minute to about 10 minutes. In another embodiment, the radiation is applied for approximately 2 minutes. The intensity of the UV radiation may be from about 5 Joules/cm² to about 5000 Joules/cm². In one embodiment, the intensity of radiation applied was approximately 100 Joules/cm² to about 150 Joules/cm². In one embodiment, the applied radiation may vary in intensity over the duration the radiation is applied to the coating layer 20.

The switchable window 10 may be operated to switch between a generally opaque state and a light transmissive state by applying or removing an electrical current to the switchable window 10. When an electrical current is applied to the switchable window 10 the liquid crystals 24 align in a fashion that is transmissive to visible light. When the current is removed or not applied to the device, the liquid crystals 24 realign to a state that is less transmissive to visible light providing a window that is generally opaque and may have the appearance of being frosted.

### EXAMPLES

The invention will now be described and may be further understood with respect to the following examples. These examples are intended to be illustrative only and are to be understood as not limiting the invention disclosed herein in any way as to materials, or process parameters, equipment or conditions.

All percentages given herein, unless otherwise noted, are to be considered weight percentages. UV radiation was applied to the formulations at the intensity of 100-150 Joules/cm² for approximately two minutes before physical characteristics of the formulation were evaluated.

In Examples 13-14 soda lime glass spheres were added. The soda lime spheres selected had two sizes, 20-27μ at 95% uniformity and 32-40μ at 95% uniformity. Both had a refractive index of 1.47. Examples 13-14 also included the addition of a solvent, ethyl alcohol denatured with ethyl acetate and methyl isobutyl acetone (“Tecsol C Anhydrous”).

### Example 1

A formulation containing 66% nematic liquid crystal, 11% acrylic acid (monomer), 11% methyl methacrylate (monomer), 11% aliphatic polyester urethane dimethacrylate (oligomer), and 1% 1-Hydroxy-cyclohexyl-phenyl-ketone.

After UV radiation was applied it was found that the formulation was clear, wet residue on surface and had poor adhesion to glass.

### Example 2

A formulation containing 66% nematic liquid crystal, 33% aliphatic polyester urethane dimethacrylate (oligomer), and 1% 1-Hydroxy-cyclohexyl-phenyl-ketone.

After UV radiation was applied it was found that the formulation was hazy white, wet residue on surface and had better adhesion to glass.

### Example 3

A formulation containing 66% nematic liquid crystal, 33% acrylic acid (monomer), and 1% 1-Hydroxy-cyclohexyl-phenyl-ketone.

After UV radiation was applied it was found that the formulation was hazy white, brittle, a good cure with poor adhesion.

### Example 4

A formulation containing 66% nematic liquid crystal, 33% methyl methacrylate (monomer), and 1% 1-Hydroxy-cyclohexyl-phenyl-ketone.

After UV radiation was applied it was found that the formulation was clear, a poor cure, and moist in nature.

### Example 5

A formulation containing 66% nematic liquid crystal, 16.5% acrylic acid (monomer), 16.5% aliphatic polyester urethane dimethacrylate (oligomer), and 1% 1-Hydroxy-cyclohexyl-phenyl-ketone.

After UV radiation was applied it was found that the formulation was hazy white, broke into pieces, and was very brittle.

### Example 6

A formulation containing 66% nematic liquid crystal, 33% hydroxyethyl methacrylate, 11% and 1% 1-Hydroxy-cyclohexyl-phenyl-ketone.

After UV radiation was applied it was found that the formulation was white and gooey soft.

### Example 7

A formulation containing 66% nematic liquid crystal, 16.5% hydroxyethyl methacrylate 16.5% aliphatic polyester urethane dimethacrylate (oligomer), and 1% 1-Hydroxy-cyclohexyl-phenyl-ketone.

After UV radiation was applied it was found that the formulation was white and breakable.

### Example 8

A formulation containing 66% nematic liquid crystal, 11% acrylic acid (monomer), 11% hydroxyethyl methacrylate, 11% aliphatic polyester urethane dimethacrylate (oligomer), and 1% 1-Hydroxy-cyclohexyl-phenyl-ketone.

After UV radiation was applied it was found that the formulation was white and breakable.

### Example 9

A formulation containing 66% nematic liquid crystal, 10% hydroxyethyl methacrylate 23% aliphatic polyester urethane dimethacrylate (oligomer), and 1% 1-Hydroxy-cyclohexyl-phenyl-ketone.

After UV radiation was applied it was found that the formulation was white, soft, and moist, and had poor adhesion.

### Example 10

A formulation containing 66% nematic liquid crystal, 5% acrylic acid (monomer), 5% hydroxyethyl methacrylate, 21% aliphatic polyester urethane dimethacrylate (oligomer), and 3% 1-Hydroxy-cyclohexyl-phenyl-ketone.

After UV radiation was applied it was found that the formulation was hazy white, brittle and had poor adhesion to glass.

### Example 11

A formulation containing 66% nematic liquid crystal, 5% acrylic acid (monomer), 10% CD 400 (oligomer), 16% aliphatic polyester urethane dimethacrylate (oligomer), and 3% 1-Hydroxy-cyclohexyl-phenyl-ketone.

After UV radiation was applied it was found that the formulation was hazy white, brittle and had poor adhesion.

### Example 12

A formulation containing 66% nematic liquid crystal, 5% acrylic acid (monomer), 5% CD 400 (oligomer), 11% aliphatic polyester urethane dimethacrylate (oligomer), 10% aliphatic polyester urethane diacrylate oligomer blended with 2(2-ethoxyethoxy) ethyl acrylate, and 3% 1-Hydroxy-cyclohexyl-phenyl-ketone.

After UV radiation was applied it was found that the formulation was white, gooey and had a wet surface.

### Example 13

A formulation containing 58.9% nematic liquid crystal, 5% acrylic acid (monomer), 5% hydroxyethyl methacrylate, 15% aliphatic polyester urethane dimethacrylate (oligomer), 0.1% fluorosurfactant, 1% 1-Hydroxy-cyclohexyl-phenyl-ketone, 10% soda lime spheres and 5% Tecsol C Anahydrous.

After UV radiation was applied it was found that the formulation had good clarity but not acceptable, less opaque than preferred, and cured very well. The viscosity was good for coatability and it was very electro conductive.

### Example 14

A formulation containing 70% nematic liquid crystal, 2.5% acrylic acid (monomer), 2.5% hydroxyethyl methacrylate, 13.9% aliphatic polyester urethane dimethacrylate (oligomer), 0.1% fluorosurfactant, 1% 1-Hydroxy-cyclohexyl-phenyl-ketone, 5% soda lime spheres and 5% Tecsol C Anahydrous.

After UV radiation was applied it was found that the formulation produced optimal results. The formulation had very clear light transmission under electro conductivity and an appreciable opacity under no current. The adhesive properties were extremely strong and well bonded; the viscosity was acceptable for performance using a reverse roll coater.

The invention has been described with reference to the various embodiments. Obviously, modifications and alternations may occur to others upon a reading and understanding of this specification. The claims as follows are intended to include all modifications and alterations insofar as they come within the scope of the claim or an equivalent thereof.

Having thus described the invention, we claim:

1. A switchable window comprising:
a first substrate;
a second substrate; and
a coating layer disposed between a first substrate and a second substrate, said coating layer comprising:
a plurality of liquid crystal elements;
at least one monomer; and
at least one oligomer, wherein the wt. % of said at least one oligomer is greater than the wt. % of said at least one monomer in said coating layer.

2. The switchable window of claim 1, wherein the ratio of wt. % of said at least one oligomer to the wt. % of said at least one monomer is from about 1.1:1 to about 7:1.

3. The switchable window of claim 1, wherein the ratio of wt. % of said at least one oligomer to wt. % of said at least one monomer is from about 2:1 to about 4:1.

4. The switchable window of claim 1, wherein said at least one monomer is chosen from an acrylate, a methacrylate, acrylic acid, methacrylic acid, salts of acrylic acid, salts of methacrylic acid, or combinations of two or more thereof.

5. The switchable window of claim 1, wherein said at least one monomer is chosen from hydroxyethyl methacrylate, acrylic acid, or a combination thereof.

6. The switchable window of claim 1, wherein said at least one oligomer, comprises an acrylated urethane oligomer, a methacrylated urethane oligomer, or a combination of two or more thereof.

7. The switchable window of claim 1, wherein said first and second substrates comprise a conductive layer disposed on a surface thereof that contacts the coating layer.

8. The switchable window of claim 1, wherein said coating layer further comprises at least one surfactant.

9. The switchable window of claim 1, wherein said coating layer further comprises at least one curing agent.

10. The switchable window of claim 1, wherein said coating layer further comprises at least one solvent.

11. The switchable window of claim 1, wherein said coating layer further comprises at least one spacer.

12. The switchable window of claim 11, wherein said at least one spacer comprises one or more soda lime sphere.

13. The switchable window of claim 8, wherein said at least one surfactant comprises a fluorosurfactant.

14. The switchable window of claim 10, wherein said at least one solvent includes ethyl alcohol, ethyl alcohol denatured with ethyl acetate, methyl isobutyl acetone or a combination of two or more thereof.

15. The switchable window of claim 9, wherein said at least one curing agent comprises 1-Hydroxy-cyclohexyl-phenyl-ketone.

16. The switchable window of claim 1, wherein said liquid crystal elements comprise nematic liquid crystals.

17. The switchable window of claim 1, wherein the coating layer is cured.

18. A switchable window comprising a coating layer disposed between a first substrate and a second substrate, said coating layer comprising:
nematic liquid crystal;
acrylic acid monomer and hydroxyethyl methacrylate monomer;
an aliphatic polyester urethane dimethacrylate oligomer, wherein the concentration of oligomer is greater than the concentration of total monomer;
a fluorosurfactant;
a photoinitiator;
a solvent; and
spacer elements comprising soda lime spheres.

19. A method of forming a switchable window, comprising the steps of;
providing a first substrate;
applying a coating layer to a surface of the first substrate, said coating layer comprising liquid crystal, at least one monomer, at least one oligomer, and a curing agent, wherein the wt. % of said at least one oligomer in said coating layer is greater than the wt. % of said at least one monomer in said coating layer;
placing a second substrate on said first substrate such that said coating layer is disposed between said first substrate and said second substrate; and
curing said coating layer.

20. The method of claim 19, wherein said first substrate and said second substrate each comprise coated with a conductive layer disposed on a surface adjacent to the coating layer.

21. The method of claim 19, wherein said coating layer is applied to said first substrate by roll coating.

22. The method of claim 19, wherein curing said coating layer comprises exposing the coating layer to UV radiation having an intensity of from about 100 to about 150 J/cm².

23. The method of claim 19, wherein curing said coating layer comprises exposing the coating layer to UV radiation for a period of from about 1 minute to about 240 minutes.

24. The method of claim 19, wherein the ratio of oligomer to monomer in the coating layer is from about 1.1:1 to about 7:1.

25. A switchable window comprising:
a coating layer disposed between a first substrate and a second substrate, the coating layer comprising:
a monomer chosen from an acrylate monomer, a methacrylate monomer, an acrylic acid, a salt of an acrylic acid, a methacrylic acid, a salt of a methacrylic acid, or a combination of two or more thereof;
at least one methacrylated urethane oligomer;
at least one surfactant;
at least one spacer;
a least one solvent; and
at least one curing agent, wherein the ratio of said oligomer to said monomer is from about 1.1:1 to about 7:1.
